(19) United States
(12) Patent Application Publication
(10) Pub. No.: US 2013/0186533 A1
(43) Pub. Date: Jul. 25, 2013

(54) TREAD FOR WINTER-USE PNEUMATIC TIRES

(71) Applicant: Shuichi KANEKO, Ota-shi (JP)

(72) Inventor: Shuichi KANEKO, Ota-shi (JP)

(73) Assignees: MICHELIN RECHERCHE ET TECHNIQUE S.A., Granges-Paccot (CH); COMPAGNIE GENERALE DES ETABLISSEMENTS MICHELIN, Clermont-Ferrand (FR)

(21) Appl. No.: 13/819,945

(22) PCT Filed: Aug. 31, 2010
(86) PCT No.: PCT/JP2010/064807

§ 371 Date: Apr. 9, 2013

(51) Int. Cl. B60C 11/03

(52) U.S. Cl. CPC B60C 11/032
USPC 152/209.17

(57) ABSTRACT

To provide a winter-use pneumatic tire with which the performance on ice can be enhanced and tread pattern durability can be enhanced. The tread for a winter-use pneumatic tire according to the present invention has blocks which are aligned in the circumferential direction and in which are formed respectively at least one thin incision which extends substantially parallel to a circumferential direction edge and which has a widened portion at its bottom, and at least one series of small holes comprising at least two small holes which open in a ground contacting surface of the block and extend in the inward radial direction of the tire, and the at least one series of small holes is formed in a neighboring region of the circumferential direction edge, and is formed in an intermediate portion between the circumferential direction edge and the at least one thin incision.

### TECHNICAL FIELD

The present invention relates to a tread for a winter-use pneumatic tire, and in particular relates to a tread for a winter-use pneumatic tire which has a plurality of blocks demarcated by circumferential grooves and transverse grooves.

### BACKGROUND ART

The treads of winter-use pneumatic tires predominantly employ block patterns, and performance on snow is enhanced by snow becoming caught in spaces between two blocks that are adjacent in the direction of rotation of the tire. Also, performance on ice is enhanced by means of a so-called edge effect and by an effect of removing a water film on the ice surface by providing these blocks with a plurality of so-called sipes which extend in the width direction of the tire.

As means for further enhancing the performance on ice there are known techniques whereby the density of the sipes provided in the blocks is increased, and the edge effect and the effect of removing the water film on the ice surface are enhanced. However, if the density of the sipes provided in the blocks is increased then the block rigidity decreases, and as a result the amount of deformation of the block increases and the durability of the tread pattern decreases.

Patent literature article 1 discloses a technique aimed at achieving both performance on ice and durability of the tread pattern by providing the blocks with a plurality of sipes and forming small holes which open in a ground contacting surface.

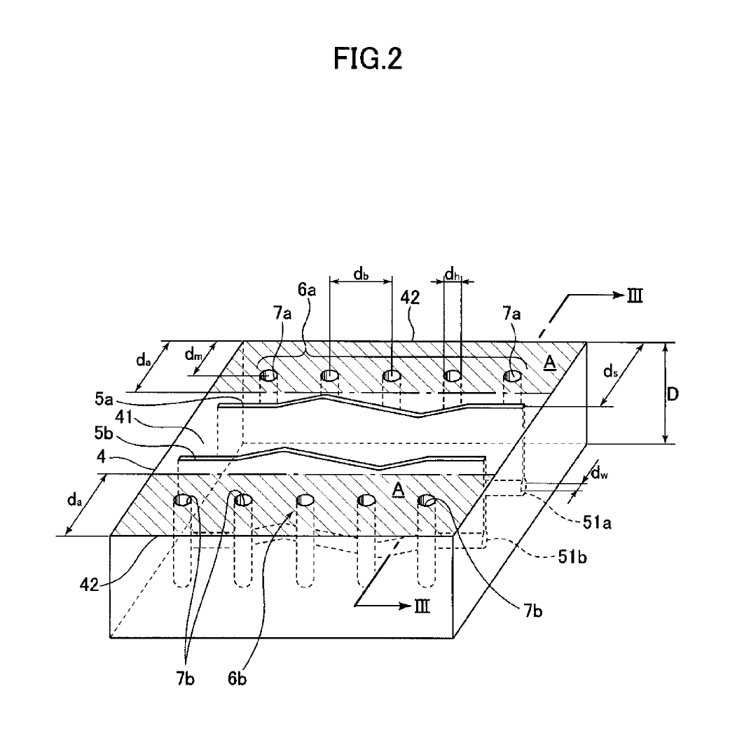

Further, FIG. 2 of Patent literature article 2 discloses a technique aimed at enhancing performance on icy and snowy road surfaces, in which blocks located in a central region of the tread are provided with sipes which extend in the width direction of the tire, and elliptically shaped pinholes (small holes) are disposed in end portions of said blocks.

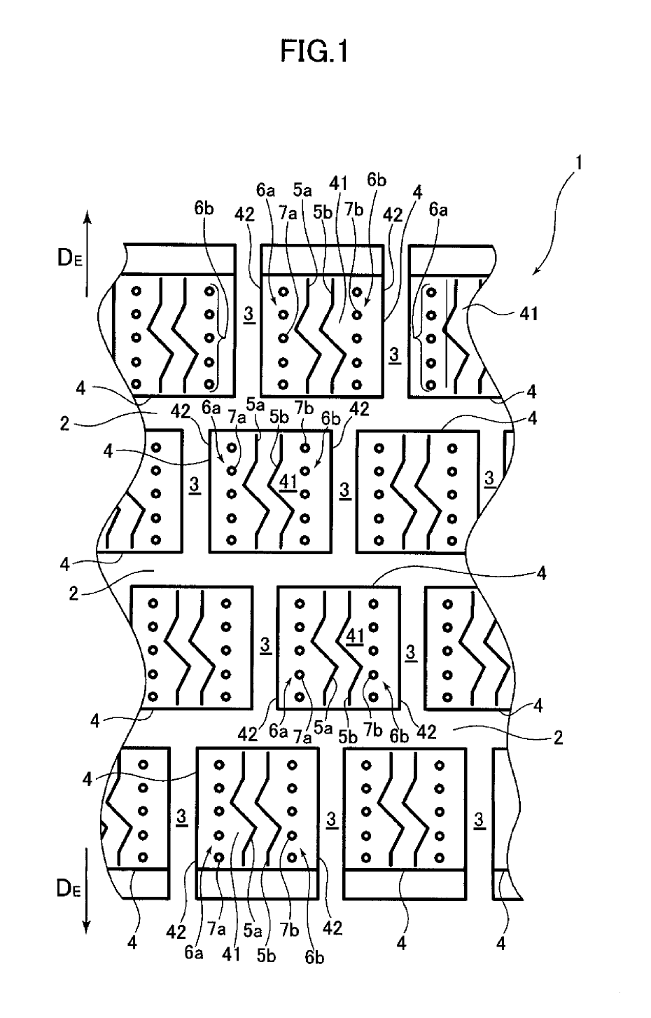

Further, FIG. 1 of Patent literature article 3 discloses a technique aimed at enhancing performance on icy and snowy road surfaces by dividing blocks into three regions by providing the blocks with two relatively thick sipes (dividing auxiliary grooves) which extend in the width direction of the tire and substantially parallel to other sipes, and providing the central region with sipes and disposing small holes in the other regions.

### PRIOR ART LITERATURE

### Patent Literature

Patent literature article 1: Japanese Patent Kokai 2005-297695

Patent literature article 2: Japanese Patent Kokai 2007-182133

Patent literature article 3: Japanese Patent Kokai 2006-168498

### SUMMARY OF THE INVENTION

### Problems to be Resolved by the Invention

However, with the technique disclosed in Patent literature article 1 there is the problem that durability of the tread pattern cannot be adequately maintained, predominantly as a result of the disposition of the sipes and the disposition of the small holes.

Further, there is a problem with the elliptical small holes disclosed in Patent literature article 2 in that there is concern that the durability of the tread pattern may be deteriorated by concentration of stress at the elliptical end portions when the tire is rotating.

Further, with the technique disclosed in Patent literature article 3 there is the problem that provision of relatively thick sipes causes the area of the ground contacting surface of the blocks to be reduced, deteriorated the performance on ice.

To this end, the present invention is intended to resolve the problems faced by the prior art described above, and its aim is to provide a winter-use pneumatic tire with which the performance on ice can be enhanced and tread pattern durability can be enhanced. Means of overcoming the problems

In order to achieve the abovementioned objective, the present invention is a tread for a winter-use pneumatic tire having at least one circumferential groove extending in the circumferential direction of the tire, a plurality of transverse grooves extending in the transverse direction of the tire, and a plurality of blocks demarcated by the circumferential grooves and the transverse grooves, characterized in that it has blocks which are aligned in the circumferential direction and in which are formed respectively circumferential direction edges formed by the transverse grooves, at least one thin incision which extends substantially parallel to the circumferential direction edges and has a depth equal to or less than the depth of the circumferential groove, and which has a widened portion at its bottom, and at least one series of small holes comprising at least two small holes which open in the ground contacting surface of the block, extend in the inward radial direction of the tire and have a depth equal to or less than the depth of the circumferential groove, and in that the at least one series of small holes is formed in a specific region neighboring the circumferential direction edge, and is formed in an intermediate portion between the circumferential direction edge and the at least one thin incision.

Here, ‘circumferential direction edge’ refers to a block end portion (edge) substantially parallel to a transverse groove which demarcates a block, from among the block end portions (edges) in the surface of contact between the block and the road surface. Also, ‘thin incision’ refers to an incision formed by a knife blade or the like, also known as a so-called sipe, and the width of the thin incision at the tread outer surface is relatively small compared predominantly with the lateral grooves. Also, ‘small hole’ is one type of incision, and refers to a circular cross-sectional hole in the tread extending in the inward radial direction of the tire. Also, ‘a series of small holes’ refers to a plurality of holes arranged consecutively. Also, ‘widened portion’ refers to a section which has a width that is larger than the width of the thin incision, and which is formed integrally with and in communication with an elongated incision.

In the present invention configured as described above, a series of small holes is formed in a specific neighboring region of the circumferential direction edge in which the degree to which the block rigidity is decreased can be suppressed in comparison with a case in which an elongated incision is formed, and therefore the decrease in the block rigidity can be suppressed in comparison with a case in which an elongated incision is formed, and as a result the durability of the tread pattern can be enhanced.

Further, in the present invention, in addition to the series of small holes being formed in a specific neighboring region of the circumferential direction edge, this series of small holes is formed in such a way that it is disposed in an intermediate portion between the circumferential direction edge and a thin incision, and therefore the efficiency with which a water film on the surface of the ice can be sucked up by the series of small holes can be enhanced by means of the widened portion of the elongated incision. In other words, the block rigidity decreases locally at the perimeter of the widened portion, and therefore by means of such a disposition the series of small holes is more readily influenced by the relative decrease in the block rigidity due to the widened portion, and thus the edge effect of each small hole is increased by virtue of an increase in the edge pressure of the small holes which acts on the edge portion, the water film on the surface of the ice can be more effectively sucked up into the interior of the small holes, and therefore the performance on ice is enhanced.

Further, concentration of stress at the bottom of the thin incision is suppressed by means of the widened portion of the thin incision having a widened portion at its bottom, and also the surface area of the block that comes into contact with air is increased by means of the widened portion, and thus the heat dissipation characteristics of the block can be improved and degradation of the material used for the block due to heat can be suppressed. As a result, tread pattern durability can be more reliably enhanced.

As a result, according to the present invention it is possible to enhance the performance on ice by disposing as described above elongated incisions which achieve a first performance on ice, and a series of small holes which is disposed in such a way that the efficiency with which the water film is sucked up is enhanced by the widened portion and which achieves a second performance on ice, while at the same time enhancing tread pattern durability while maintaining a high rigidity of the block as a whole by suppressing the degree of decrease in block rigidity by forming the series of small holes in a specific neighboring region of the circumferential direction edge, and by suppressing the concentration of stress at the bottom of the elongated incision by means of the widened portion, and by suppressing degradation of the block material by means of heat dissipation in the widened portion.

In the present invention, the tread for a winter-use pneumatic tire preferably has a prescribed direction of rotation, and the specific neighboring region of the circumferential direction edge is the region neighboring the trailing side circumferential direction edge.

Here, ‘trailing side circumferential direction edge’ refers to the circumferential direction edge located to the rear in the direction of rotation of the tire, from among the circumferential direction edges.

In the present invention configured in this way, the tread pattern durability can be more effectively enhanced by forming a series of small holes, having a higher resistance to mechanical stress than a case in which a thin incision is formed, in a neighboring region of the trailing side circumferential direction edge, which is the circumferential direction edge having the highest concentration of stress when the tire is rotating.

In the present invention the separation between the circumferential direction edge and the at least one thin incision, between which at least one series of small holes is formed, is preferably between 8.0 mm and 14.0 mm. In the present invention configured in this way it is possible to achieve enhanced tread pattern durability and to suppress decreases in the performance on ice. In other words, if the separation between the circumferential direction edge and the thin incision having a widened portion at its bottom is smaller than 8.0 mm then the effect whereby the series of small holes formed in the intermediate portion suppresses the decrease in block rigidity becomes less marked, and tread pattern durability decreases. On the other hand, if the separation between the circumferential direction edge and the thin incision having a widened portion at its bottom is larger than 14.0 mm then the effect whereby the efficiency with which the water film on the surface of the ice is sucked up by the series of small holes is enhanced by means of a localised decrease in the block rigidity at the perimeter of the widened portion becomes less marked by combining the thin incision having a widened portion and the series of small holes, and the performance on ice decreases. It is therefore possible to achieve enhanced tread pattern durability and to suppress the decrease in the performance on ice if the separation between the circumferential direction edge and the at least one thin incision is set to between 8.0 mm and 14.0 mm.

In the present invention the diameter of the small holes constituting the at least one series of small holes is preferably between 1.0 mm and 3.0 mm. In the present invention configured in this way it is possible to achieve enhanced tread pattern durability and to suppress decreases in the performance on ice. In other words, if the diameter of the small holes constituting the at least one series of small holes is less than 1.0 mm then the effect whereby a water film on the surface of the ice is sucked up into the interior of these small holes is inadequate, even when combined with the effect whereby the efficiency with which the water film on the surface of the ice is sucked up by the small holes is enhanced concomitantly with a localised decrease in the block rigidity due to the widened portion, and thus the performance on ice decreases. On the other hand, if the diameter of the small holes constituting the at least one series of small holes is greater than 3.0 mm then the effect whereby the decrease in block rigidity is suppressed by means of the formation of the series of small holes in a specific neighboring region of the circumferential direction edge becomes less marked, and not only does the tread pattern durability decrease, but also the performance on ice decreases because the surface area of the block surface which is in contact with the road surface is reduced as a result of the increase in the surface area of the small holes on the surface of the block. It is therefore possible to achieve enhanced tread pattern durability and to suppress the decrease in the performance on ice if the diameter of the small holes is set to between 1.0 mm and 3.0 mm.

In the present invention the separation of the small holes constituting the at least one series of small holes is preferably between 3.0 mm and 6.0 mm. In the present invention configured in this way it is possible to achieve enhanced tread pattern durability and to suppress decreases in the performance on ice. In other words, if the separation of adjacent small holes constituting the at least one series of small holes is less than 3.0 mm then the effect whereby the decrease in block rigidity is suppressed by means of the formation of the series of small holes in a specific neighboring region of the circumferential direction edge becomes less marked, and the tread pattern durability decreases. On the other hand, if the separation of adjacent small holes constituting the at least one series of small holes is greater than 6.0 mm then the effect whereby a water film on the surface of the ice is sucked up into the interior of these small holes is inadequate, even when combined with the effect whereby the efficiency with which the water film on the surface of the ice is sucked up by the small holes is enhanced concomitantly with a localised decrease in the block rigidity due to the widened portion, and thus the performance on ice decreases. It is therefore possible to achieve enhanced tread pattern durability and to suppress the decrease in the performance on ice if the separation of adjacent small holes constituting the at least one series of small holes is set to between 3.0 mm and 6.0 mm.

In the present invention the widened portion of the at least one elongated incision preferably has a circular cross-sectional shape. In the present invention configured in this way the widened portion has a circular cross-sectional shape which typically exhibits a good balance of heat dissipation, resulting from an increase in the surface area which is in contact with the air, and stress dispersion (suppression of stress concentration), and therefore tread pattern durability can be enhanced and it is also possible to alleviate processing complications when the thin incision having a widened portion at its bottom is manufactured.

In the present invention the diameter of the circular cross section of the widened portion is preferably between 1.0 mm and 3.0 mm. In the present invention configured in this way it is possible to achieve enhanced tread pattern durability and to suppress decreases in the performance on ice. In other words, if the diameter of the circular cross section of the widened portion of the at least one elongated incision is less than 1.0 mm then the degree by which the block rigidity at the widened portion decreases locally is reduced, and even if at least one series of small holes is disposed in the intermediate portion between the circumferential direction edge and the thin incision having a widened portion, the effect whereby the efficiency with which the water film on the surface of the ice is sucked up by the series of small holes is enhanced decreases. On the other hand, if the diameter of the circular cross section of the widened portion of the at least one elongated incision is greater than 3.0 mm then the degree of localised decrease in the block rigidity at the widened portion is increased, rigidity of the whole block is liable to decrease, and the tread pattern durability decreases. It is therefore possible to achieve enhanced tread pattern durability and to suppress the decrease in the performance on ice if the diameter of the circular cross section of the widened portion of the at least one elongated incision is set to between 1.0 mm and 3.0 mm.

In the present invention the blocks aligned in the circumferential direction are preferably formed on the tread shoulder portion.

Here, ‘tread shoulder portion’ refers to the region of the tread portion located on the outermost side in the width direction of the tire.

In the present invention configured in this way, the tread pattern durability can be effectively enhanced because the blocks aligned in the circumferential direction are formed in the tread shoulder portion which serves a more important function than other regions of the tread when the tire is rolling, and which generates more heat than other portions of the tread.

In the present invention the at least one elongated incision is preferably formed in such a way that it opens in the block wall located on the outside of the tread.

Here, ‘outside of the tread’ refers to the direction facing to the outside in the width direction of the tire. Further, ‘block wall’ refers to the section which faces the groove at the side surface of the block. When a block is located in the tread shoulder portion, the block side surface located on the outside of the tread is also called a block wall.

In the present invention configured in this way, degradation due to heat in the material used for the blocks can be more effectively suppressed, thereby enhancing the tread pattern durability, because heat within the block is dissipated through the open portion which is open in the block wall and a high heat dissipation characteristic can thus be obtained.

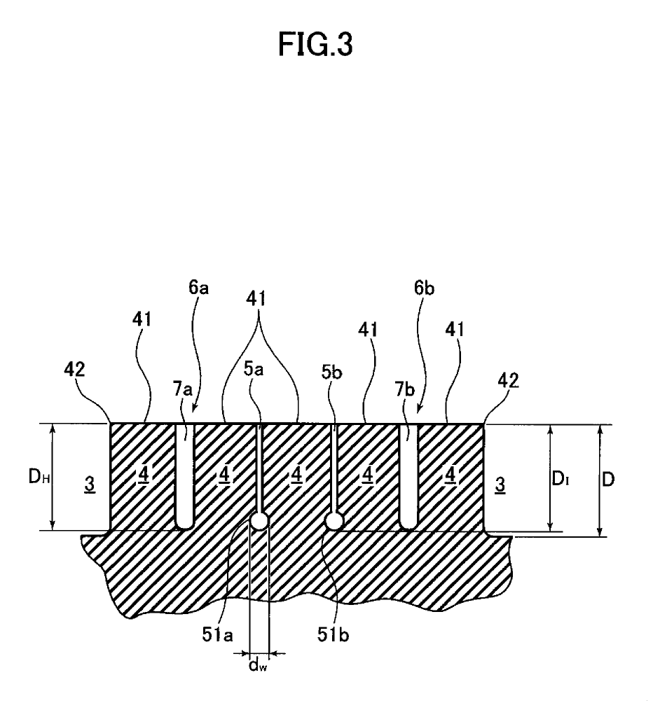

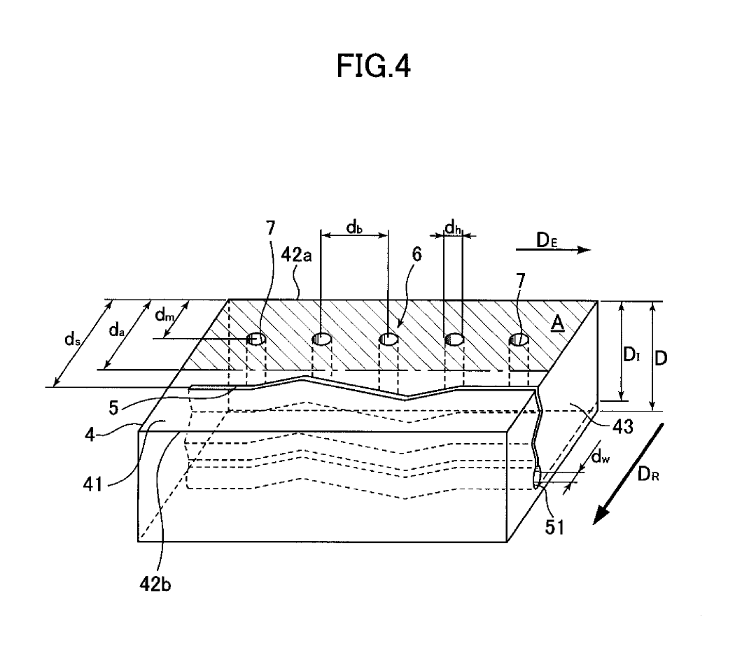

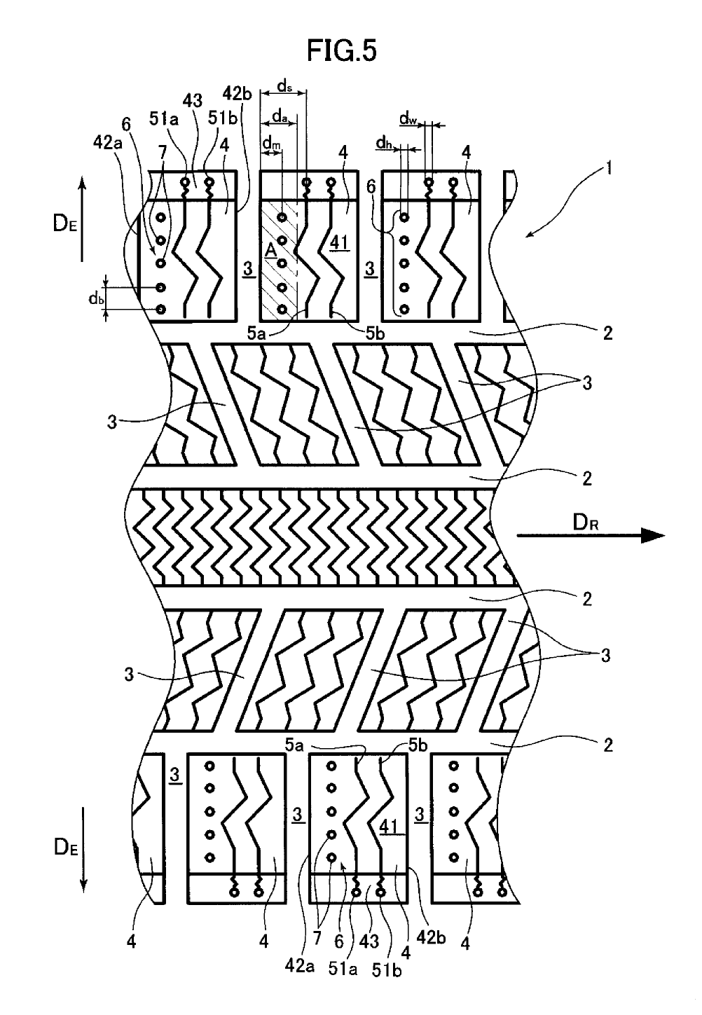

### BRIEF EXPLANATION OF THE FIGURES

[FIG. 1] is a diagram illustrating schematically a tread for a winter-use pneumatic tire according to a first mode of embodiment of the present invention.

[FIG. 2] is a diagram illustrating schematically a block in the tread for a winter-use pneumatic tire according to the first mode of embodiment of the present invention.

[FIG. 3] is an enlarged sectional view of the tread for a winter-use tire as viewed along line III-III in FIG. 2.

[FIG. 4] is a diagram illustrating schematically a block in the tread for a winter-use pneumatic tire according to a second mode of embodiment of the present invention.

[FIG. 5] is a diagram illustrating schematically a tread for a winter-use pneumatic tire according to a third mode of embodiment of the present invention.

### MODES OF EMBODYING THE INVENTION

Preferred modes of embodiment of the present invention will now be described with reference to the diagrams. First, a tread for a winter-use pneumatic tire according to a first mode of embodiment of the present invention will be described based on FIG. 1 to FIG. 3. FIG. 1 is a diagram illustrating schematically a tread for a winter-use pneumatic tire according to a first mode of embodiment of the present invention, FIG. 2 is a diagram illustrating schematically a block in the tread for a winter-use pneumatic tire according to the first mode of embodiment of the present invention, and FIG. 3 is an enlarged sectional view of the tread for a winter-use tire as viewed along line III-III in FIG. 2.

First, as shown in FIG. 1, reference number 1 indicates a winter-use pneumatic tire tread according to a first mode of embodiment. It should be noted that the size of the tire in this example is 205/55R16. In the tread 1 are formed three circumferential grooves 2 extending in the circumferential direction of the tire and a plurality of transverse grooves 3 extending in the transverse direction (width direction) of the tire. Reference number 4 indicates a block in the winter-use tire tread 1 according to the first mode of embodiment, and the blocks 4 are formed by being demarcated by the circumferential grooves 2 and the transverse grooves 3, and further, circumferential direction edges 42 are formed by means of the transverse grooves 3. It should be noted that in the winter-use tire tread 1 in the present mode of embodiment, the direction of rotation of the tire is not prescribed.

Next, as shown in FIG. 2 and FIG. 3, the blocks 4 are formed in such a way that they have the same block height as the depth D of the circumferential grooves 2, and further they have a surface 41 which comes into contact with the road surface when the tire is rolling. The transverse grooves 3 have the same depth D as the circumferential grooves 2. In the present mode of embodiment, the depth D of the circumferential grooves 2 is 9.2 mm. Further, as shown in FIG. 3, circumferential direction edges 42 face the transverse grooves 3.

Next, as shown in FIGS. 1 to 3, series of small holes 6 comprising a plurality of small holes 7, and thin incisions 5 are formed in each block 4. In the present mode of embodiment, a set comprising a thin incision 5a and a series of small holes 6a comprising small holes 7a, and a set comprising a thin incision 5b and a series of small holes 6b comprising small holes 7b are provided on each of the circumferential direction edge 42 sides of the block 4. The configuration and action of these two sets are the same as each other, so predominantly only one set will be described hereinbelow.

The configuration and action of the series of small holes 6 will first be described. As shown in FIG. 2 and FIG. 3, a series of small holes 6a (6b) has five small holes 7a (7b) which open in a surface 41 which comes into contact with the road surface, and which extend in the inward radial direction of the tire, and which each have a depth DH which is less than or equal to the depth D of the circumferential grooves 2, and these small holes 7a (7b) are configured in a consecutive arrangement. In the present mode of embodiment, the series of small holes 6a (6b) is configured in such a way that the small holes 7a are aligned in a straight line. It should be noted that in the present mode of embodiment the series of small holes 6a (6b) consist of five small holes 7a (7b), but they may consist of at least two or more small holes, without limitation to the example illustrated. The maximum depth DH of the small holes 7 is the same D as the circumferential grooves 2. In the present mode of embodiment, the depth DH of the small holes 7 is 7.5 mm.

The two series of small holes 6a, 6b are each formed in neighboring regions A of circumferential direction edges 42, which are end portions substantially parallel to the transverse grooves 3 which demarcate the block 4. These neighboring regions A are regions in which it is possible to suppress the degree of decrease in block rigidity more by forming a series of small holes than by forming an elongated incision, and as shown in FIG. 2, they are regions which extend in the circumferential direction of the tire for a distance da from the circumferential direction edges 42. In the blocks 4 in the present mode of embodiment, the distance da is 8 mm. In the present mode of embodiment, the tread pattern durability is enhanced by forming series of small holes 6a, 6b in these neighboring regions A to suppress the decrease in block rigidity.

Next, as shown in FIG. 1 and FIG. 2, the series of small holes 6a (6b) are formed in such a way that the small holes 7a (7b) are aligned substantially parallel to the circumferential direction edge 42 in the neighboring region A of the circumferential direction edge 42. In the present mode of embodiment, the separation dm between the circumferential direction edge 42 and the series of small holes 6a (6b) is 5.0 mm. Further, in the present mode of embodiment the diameter dh (see FIG. 2) of each small hole 7 constituting the series of small holes 6 is 1.5 mm, and the separation db between adjacent small holes 7 (see FIG. 2) is 5.0 mm.

The configuration and action of the thin incisions 5 will next be described. First, as shown in FIG. 1 to FIG. 3, thin incisions 5a (5b) which extend in the inward radial direction of the tire and which open in the surface 41 which comes into contact with the road surface are formed in the block 4, in the central region of the block. As shown in FIG. 1 and FIG. 2, the thin incisions 5a (5b) are formed in such a way that as a whole they extend in the transverse direction of the tire, and such that they extend substantially parallel to the circumferential direction edge 42.

Next, as shown in FIG. 2 and FIG. 3, a widened portion 51a (51b) having a circular cross-section is formed at the bottom of the thin incision 5a (5b), extending in the transverse direction of the tire and extending substantially parallel to the circumferential direction edge 42. The widened portion 51a (51b) is a space formed integrally with the thin incision 5a (5b) in such a way that it communicates with the bottom of the thin incision 5a (5b) and enlarges the width of the bottom of the thin incision 5. The maximum depth DI of the thin incision 5a (5b) including the widened portion 51a (51b) (see FIG. 3) is the same as the depth D of the circumferential groove 2. In the present mode of embodiment, the depth DI of the thin incision 5a (5b) including the widened portion 51a (51b) is 7.5 mm, and the diameter dw of the widened portion 51a (51b) having a circular cross-section (see FIG. 3) is 1.5 mm.

The thin incisions 5a (5b) which open in the surface 41 of the block 4 which comes into contact with the road surface enhance the performance on ice, not only by exhibiting a so-called edge effect as an edge additional to the circumferential direction edge 42, but also by exhibiting an effect of stimulating direct contact between the block 4 and the ice by taking into the incised portion of the thin incision 5 a film of water which exists between the block 4 and the ice.

Further, the widened portion 51 formed at the bottom of the thin incision 5 suppresses the concentration of stress at the bottom of the thin incision 5, and also enhances the heat dissipation effect of the block 4 by increasing the area of the surface inside the block 4 which comes into contact with air by an amount corresponding to the widened portion 51, and enhances the tread pattern durability by suppressing degradation, due to heat, of the material used for the blocks 4. In the present mode of embodiment, the separation ds between the circumferential direction edge 42 and the thin incision 5a (5b) is 10.0 mm.

The disposition and action of the circumferential direction edges 42, the series of small holes 6a (6b) and the thin incisions 5 will now be described. Here, typically forming a series of small holes suppresses the decrease in block rigidity more than forming a thin incision, and it is thus possible to ensure a high overall block rigidity, but on the other hand it is difficult to increase the edge pressure of the series of small holes, acting on the edge portion, to compensate for the amount by which the decrease in block rigidity is suppressed in a case in which a series of small holes is formed compared with a case in which an elongated incision is formed, and thus an enhancement of performance on ice cannot be obtained using small holes.

For this reason, in the present mode of embodiment, firstly by forming a widened portion 51a (51b) at the bottom of the thin incision 5a (5b), the rigidity at the periphery of the widened portion 51a (51b) is caused to decrease locally, and the edge pressure of the small holes which acts on the edge portion is increased by disposing the series of small holes 6a (6b) in the region in which the block rigidity has decreased locally. Specifically, in the present mode of embodiment, the series of small holes 6a (6b) is formed/disposed in a neighboring region of the circumferential direction edge 42, as described hereinabove, and as shown in FIG. 1 to FIG. 3 the series of small holes 6a (6b) is formed/disposed in an intermediate portion between the circumferential direction edge 42 and the thin incision 5a (5b).

In the present mode of embodiment, by means of this disposition the rigidity at the periphery of the series of small holes 6a (6b) is caused to decrease locally, the edge pressure of the series of small holes which acts on the edge portion is increased, and on ice the series of small holes 6 exhibits a so-called edge effect as an edge additional to the circumferential direction edge 42 and the thin incision 5a (5b), and a water film which exists between the block and the ice is taken into the interior of the small holes 6 which thereby exhibit an effect whereby direct contact between the block and the water is stimulated, and thus the performance on ice is enhanced.

In the present mode of embodiment, the separation between the series of small holes 6a (6b) and the circumferential direction edge 42 is 5.0 mm, which is half of the separation ds (=10 mm) between the circumferential direction edge 42 and the thin incision 5a (5b) which has a widened portion 51a (51b) at its bottom. In other words, in the present mode of embodiment the series of small holes 6a (6b) is disposed in an intermediate location between the circumferential direction edge 42 and the thin incision 5a (5b) which has a widened portion 51a (51b) at its bottom. It should be noted that if the separation ds between the circumferential direction edge 42 and the thin incision 5a (5b) is 10 mm, then the effect whereby the edge pressure of the series of small holes 6a (6b) is increased by means of the widened portion 51a (51b) described above can be effectively obtained provided that the series of small holes 6a (6b) is formed in the intermediate portion between the circumferential direction edge 42 and the thin incision 5a (5b) in such a way that the separation dm between the series of small holes 6a (6b) and the circumferential direction edge 42 is in the range of 4.0 mm to 6.0 mm. It should be noted that if, as described hereinbelow, the separation ds between the circumferential direction edge 42 and the thin incision 5a (5b) is not set to 10.0 mm as in the present mode of embodiment, then the location and range of the intermediate portion in which the series of small holes is formed will also be modified proportionally according to the separation.

Here, in the example described above, the separation ds between the circumferential direction edge 42 and the thin incision 5a (5b) was 10.0 mm, but this separation ds between the circumferential direction edge 42 and the thin incision 5a (5b) may have a value of between 8.0 mm and 14.0 mm. This is because if the separation between the circumferential direction edge 42 and the thin incision 5a, 5b having a widened portion 51a, 51b at its bottom is smaller than 8.0 mm then the effect whereby the series of small holes 6a, 6b formed in the intermediate portion suppresses the decrease in block rigidity becomes less marked, and tread pattern durability decreases. On the other hand, this is because if the separation ds between the circumferential direction edge 42 and the thin incision 5a, 5b having a widened portion 51a, 51b at its bottom is larger than 14.0 mm then the effect whereby the efficiency with which a water film on the surface of the ice is sucked up by the series of small holes (6a, 6b) is enhanced by means of a localised decrease in the block rigidity at the perimeter of the widened portion (51a, 51b) becomes less marked by combining the thin incision (5a, 5b) having a widened portion (51a, 51b) and the series of small holes (6a, 6b), and the performance on ice decreases.

Further, in the example described hereinabove, the small holes 7a, 7b are formed with a diameter dh of 1.5 mm, but the diameters dh of the small holes 7a, 7b may be in the range of 1.0 mm to 3.0 mm. This is because if the diameter of the small holes (7a, 7b) constituting the series of small holes (6a, 6b) is less than 1.0 mm then the effect whereby a water film on the surface of the ice is sucked up into the interior of these small holes is inadequate, even when combined with the effect whereby the efficiency with which the water film on the surface of the ice is sucked up by the small holes (7a, 7b) is enhanced concomitantly with a localised decrease in the block rigidity due to the widened portion (51a, 51b) of the elongated incision (5), and thus the performance on ice decreases. On the other hand, this is because if the diameter of the small holes (7a, 7b) constituting the series of small holes (6a, 6b) is greater than 3.0 mm then the effect whereby the decrease in block rigidity is suppressed by means of the formation of the series of small holes (6a, 6b) in a neighboring region of the circumferential direction edge 42 becomes less marked, and not only does the tread pattern durability decrease, but also the performance on ice decreases because the surface area of the block surface which is in contact with the road surface is reduced as a result of the increase in the surface area of the small holes (7a, 7b) on the surface of the block.

Further, in the example described hereinabove, the separation db between adjacent holes 7a (7b) is 5.0 mm, but the separation db between adjacent holes 7a (7b) may be in the range of 3.0 mm to 6.0 mm. This is because if the separation db of adjacent small holes 7a (7b) constituting the series of small holes (6a, 6b) is less than 3.0 mm then the effect whereby the decrease in block rigidity is suppressed by means of the formation of the series of small holes 6a (6b) in a neighboring region A of the circumferential direction edge 42 becomes less marked, and the tread pattern durability decreases. On the other hand, this is because if the separation db of adjacent small holes 7a (7b) constituting the series of small holes 6a (6b) is greater than 6.0 mm then the effect whereby a water film on the surface of the ice is sucked up into the interior of these small holes is inadequate, even when combined with the effect whereby the efficiency with which the water film on the surface of the ice is sucked up by the small holes (7a, 7b) is enhanced concomitantly with a localised decrease in the block rigidity due to the widened portion (51a, 51b), and thus the performance on ice decreases.

Further, in the example described hereinabove, the diameter dw of the widened portion 51a (51b) having a circular cross-section is 1.5 mm, but the diameter dw of the widened portion 51a (51b) having a circular cross-section may have a value of between 1.0 mm and 3.0 mm. This is because if the diameter dw of the circular cross section of the widened portion 51a (51b) of the elongated incision 5a (5b) is less than 1.0 mm then the degree by which the block rigidity at the widened portion 51a (51b) decreases locally is reduced, and even if a series of small holes 6a (6b) is formed in the neighboring region A of the circumferential direction edge 42 and is disposed in the intermediate portion between the circumferential direction edge 42 and the thin incision 5a (5b) having a widened portion 51a (51b), the effect whereby the efficiency with which a water film on the surface of the ice is sucked up by the series of small holes 6a (6b) is enhanced decreases because the localised decrease in block rigidity at the perimeter of the widened portion 51a (51b) does not reach or is liable not to reach the series of small holes 6a (6b). On the other hand, this is because if the diameter dw of the circular cross section of the widened portion 51a (51b) of the elongated incision 5a (5b) is greater than 3.0 mm then the degree of localised decrease in the block rigidity at the perimeter of the widened portion 51a (51b) is increased, rigidity of the whole block is liable to decrease, and the tread pattern durability decreases. It should be noted that the cross-sectional shape of the widened portion 51a (51b) described above is not limited to a circular shape, and the increase in width relative to the thin incision 5a (5b) may be modified within a range that allows the action described above to be obtained.

Next, a tread for a winter-use pneumatic tire according to a second mode of embodiment of the present invention will be described based on FIG. 4. FIG. 4 is a diagram illustrating schematically a block in the tread for a winter-use pneumatic tire according to a second mode of embodiment of the present invention. The basic configuration of the tire tread according to this second mode of embodiment is the same as in the first mode of embodiment described hereinabove, and so hereinbelow the points of difference will mainly be described.

With the tread 1 in the second mode of embodiment, the direction of rotation of the tire is prescribed as shown by the arrow DR in FIG. 4 which indicates the direction of rotation. As shown in FIG. 4, in the second mode of embodiment also, block 4 is formed in such a way that it has the same block height as the depth D of the transverse grooves 3, and it has a surface 41 which comes into contact with the road surface when the tire is rolling.

A series of small holes 6, the same as that described hereinabove in the first mode of embodiment, is formed in the block 4. In this second mode of embodiment, one series of small holes 6 comprising five small holes 7 which extend in the inward direction of the tire and which open in the surface 41 which comes into contact with the road surface is formed in the block 4.

Then, in the second mode of embodiment, as shown in FIG. 4 the series of small holes 6 is formed in a neighboring region A of the trailing side circumferential direction edge 42a, which, of the neighboring regions of the circumferential direction edges 42a, 42b, has the highest concentration of stress when the tire is rotating. As in the first mode of embodiment, the neighboring region A of the trailing side circumferential direction edge 42a is a region in which it is possible to suppress the degree of decrease in block rigidity more by forming a series of small holes 6 than by forming an elongated incision, and as shown in FIG. 4, it is a region which extends in the direction of rotation of the tire DR for a distance da from the trailing side circumferential direction edge 42a. The distance da in the second mode of embodiment is 8 mm.

Also, a thin incision 5, the same as that described hereinabove in the first mode of embodiment, is formed in the block 4. In this second mode of embodiment, one thin incision 5 which extends in the inward direction of the tire and which opens in the surface 41 which comes into contact with the road surface is formed in the block 4. Also, a widened portion 51 having a circular cross-sectional shape is formed at the bottom of the thin incision 5, in the same way as in the first mode of embodiment.

The diameter dw of the widened portion 51 in the second mode of embodiment is 2 mm. Thus in the second mode of embodiment, the diameter dw of the widened portion 51 is larger than the diameter dw (=1.5 mm) of the widened portion 51 in the first mode of embodiment, and the degree of decrease in block rigidity at the perimeter of the widened portion 51 is correspondingly larger, and thus as described hereinabove by more effectively increasing the edge pressure of the series of small holes 6 which acts on the edge portion, the effect whereby water is absorbed is enhanced. Also, the surface area of the widened portion 51 is increased correspondingly as the diameter dw of the widened portion 51 is increased, and as a result the area of the surface inside the block 4 which comes into contact with air is further increased, thereby further enhancing the heat dissipating effect in the block 4 and enhancing the tread pattern durability.

In this second mode of embodiment, the thin incision 5 and its widened portion 51 open not only in the surface 41 of the block 4, but also in the block wall 43 located on the outer side of the tread as indicated by the arrow DE in FIG. 4. By means of such an opening, generation of heat when the tire is rolling is more effectively suppressed, and tread pattern durability is enhanced. It should be noted that in the present mode of embodiment the thin incision 5 at the bottom of which is formed a widened portion 51 is formed with a wave-like amplitude in both the width direction and the depth direction (including shapes such as zigzag shapes and dimensions in the width direction), including the widened portion 51, but it may be modified appropriately into another form such as a linear shape, or a form having a width that varies internally, for example.

In the second mode of embodiment, in the same way as in the first mode of embodiment described hereinabove, the series of small holes 6 is also formed in an intermediate portion between the circumferential direction edge 42a and the thin incision 5 which has a widened portion 51 at its bottom, and the dimensions of the series of small holes 6, and the dimensional relationships between the series of small holes 6, the elongated incision 5 and the circumferential direction edge 42 are the same as in the first mode of embodiment, and the same actions can be obtained thereby as described hereinabove in the first mode of embodiment.

Next, a tread for a winter-use pneumatic tire according to a third mode of embodiment of the present invention will be described based on FIG. 5. FIG. 5 is a diagram illustrating schematically a tread for a winter-use pneumatic tire according to a third mode of embodiment of the present invention. With the tread 1 in the third mode of embodiment, the direction of rotation of the tire is prescribed as shown by the arrow DR in FIG. 5 which indicates the direction of rotation, four circumferential grooves 2 are formed in the tread 1, and the tread 1 is divided into a plurality of regions which are demarcated by the circumferential grooves 2. It should be noted that the size of the tire in this example is 205/55R16.

In the present mode of embodiment the central section of the tread 1 comprises a continuous rib in which a plurality of thin incisions are formed. Also, transverse grooves 3 are formed in the region between the central section of the tread 1 and the tread shoulder portion, and in the same way a plurality of thin incisions are formed in the blocks formed thereby.

Transverse grooves 3 are also formed in the tread shoulder portion, and the blocks 4 formed thereby have a surface 41 which comes into contact with the road surface when the tire is rolling. A series of small holes 6, the same as that described hereinabove in the first mode of embodiment, is formed in the blocks 4. In this third mode of embodiment, one series of small holes 6 comprising five small holes 7 which extend in the inward direction of the tire and which open in the surface 41 which comes into contact with the road surface is formed in the blocks 4 in the tread shoulder portion.

Then, in the third mode of embodiment, as shown in FIG. 5 the series of small holes 6 is formed in a neighboring region A of the trailing side circumferential direction edge 42, which, of the neighboring regions of the circumferential direction edges 42a, 42b, has the highest concentration of stress when the tire is rotating. As in the first mode of embodiment, the neighboring region A of the trailing side circumferential direction edge 42 is a region in which it is possible to suppress the degree of decrease in block rigidity more by forming a series of small holes 6 than by forming an elongated incision, and as shown in FIG. 5, it is a region which extends in the direction of rotation of the tire DR for a distance da from the trailing side circumferential direction edge 42a. The distance da in the third mode of embodiment is 8 mm.

Also, thin incisions 5, the same as that described hereinabove in the first mode of embodiment, are formed in the blocks 4. In the third mode of embodiment, two thin incisions 5a, 5b which extend in the inward direction of the tire and which open in the surface 41 which comes into contact with the road surface are formed in the blocks 4, and widened portions 51a, 51b having a circular cross-sectional shape are formed respectively at the bottoms of the two thin incisions 5a, 5b.

The thin incisions 5a, 5b and the widened portions 51a, 51b open not only in the surface 41 of the block 4, but also in the block wall 43 located on the outer side of the tread as indicated by the arrow DE in FIG. 5. By means of such an opening, generation of heat when the tire is rolling can be more effectively suppressed, and thus tread pattern durability can be enhanced. It should be noted that in the present mode of embodiment the thin incisions 5 at the bottom of which are formed widened portions 51 are formed with a wave-like amplitude in both the width direction and the depth direction, including the widened portions 51, but they may be modified appropriately into another form such as a linear shape, or a form having a width that varies internally, for example.

The blocks 4 in this third mode of embodiment are formed in the tread shoulder portion, which serves a more important function than other regions of the tread in terms of generation of heat in the blocks 4 of the tread 1 when the tire is rolling, and thus the tread pattern durability can be more effectively enhanced.

Also, in the third mode of embodiment, the series of small holes 6 is formed in an intermediate portion between the circumferential direction edge 42a and the thin incision 5a which has a widened portion 51a at its bottom, from among the thin incisions 5a, 5b, and in the same way as in the first mode of embodiment described hereinabove, the dimensions of the series of small holes 6, and the dimensional relationships between the series of small holes 6, the elongated incision 5a and the circumferential direction edge 42a are the same as in the first mode of embodiment, and the same actions can be obtained thereby as described hereinabove in the first mode of embodiment. The other thin incision 5a having a widened portion 51b contributes to heat dissipation and to enhancing further the performance on ice of the block 4.

Particularly preferred modes of embodiment of the present invention have been described hereinabove, but the present invention may be modified and implemented in the form of various embodiments without limitation to the modes of embodiment illustrated.

Next, the main operational advantages of the first to third modes of embodiment of the present invention will be described based on FIG. 1 to FIG. 3. The tread 1 for a winter-use pneumatic tire according to the first to third modes of embodiment has blocks 4 which are aligned in the circumferential direction and in which are formed respectively circumferential direction edges 42 formed by transverse grooves 3, at least one thin incision 5 which extends substantially parallel to the circumferential direction edges 42 and has a depth DI equal to or less than the depth D of a circumferential groove 2, and which has a widened portion 51 at its bottom, and at least one series of small holes 6 comprising at least two small holes 7 which open in a ground contacting surface 41 of the block 4, extend in the inward radial direction of the tire and have a depth DH equal to or less than the depth D of the circumferential groove 2, and the at least one series of small holes 6 is formed ‘in a specific region neighboring the circumferential direction edge 42’ in such a way that the small holes 7 are aligned substantially parallel to the circumferential direction edge 42, in other words ‘in a neighboring region of the circumferential direction edge in which the degree to which the block rigidity is decreased can be suppressed in comparison with a case in which an elongated incision is formed (in the first to third modes of embodiment described hereinabove, a region A a distance da of 8 mm from the circumferential direction edge 42 or the trailing side circumferential direction edge 42a)’ and therefore decreases in the block rigidity can be suppressed in comparison with a case in which an elongated incision is formed, and as a result the durability of the tread pattern can be enhanced. In other words, if the elongated incision which achieves a first function of maintaining performance on ice is formed in the vicinity of the circumferential direction edge 42, then the degree of decrease in the rigidity of the block 4 is large, and therefore if as in the modes of embodiment described hereinabove a series of small holes 6 achieving a second function of maintaining performance on ice is formed in the neighboring region A of the circumferential direction edge 42 or the trailing side circumferential direction edge 42a then the decrease in block rigidity can be suppressed.

Further, in the first to third modes of embodiment, in addition to the series of small holes 6 being formed in the neighboring region A of the circumferential direction edge 42 or the trailing side circumferential direction edge 42a, this series of small holes 6 is formed in such a way that it is disposed in an intermediate portion between the circumferential direction edge 42 and a thin incision 5, and therefore the efficiency with which a water film on the surface of the ice can be sucked up by the series of small holes 6 can be enhanced by means of the widened portion 51 of the elongated incision 5. In other words, the block rigidity decreases locally at the perimeter of the widened portion 51, and therefore by means of such a disposition the series of small holes 6 is more readily influenced by the relative decrease in the block rigidity due to the widened portion 51, and thus the edge effect of each small hole 7 is increased by virtue of an increase in the edge pressure of the small holes 6 which acts on the edge portion, the water film on the surface of the ice can be more effectively sucked up into the interior of the small holes, and therefore the performance on ice is enhanced.

Further, according to the first to third modes of embodiment it is possible to enhance the performance on ice by disposing, as described above in the first to third modes of embodiment, elongated incisions 5 which achieve a first performance on ice, and a series of small holes 6 which is disposed in such a way that the efficiency with which the water film is sucked up is enhanced by the widened portion 51 and which achieves a second performance on ice, while at the same time enhancing tread pattern durability while maintaining a high rigidity of the block as a whole by suppressing the degree of decrease in block rigidity by forming the series of small holes 6 in a neighboring region A of the circumferential direction edge 42 or the trailing side circumferential direction edge 42a, and by suppressing the concentration of stress at the bottom of the elongated incision 5 by means of the widened portion 51, and by suppressing degradation of the block 4 material by means of heat dissipation in the widened portion 51.

Also, according to the second and third modes of embodiment, the tread for a winter-use pneumatic tire has a prescribed direction of rotation DR, and in a block 4 of such a tread 1 the tread pattern durability can be more effectively enhanced by forming a series of small holes 6, having a higher resistance to mechanical stress than a case in which a thin incision is formed, in a neighboring region A of the trailing side circumferential direction edge 42a, which is the circumferential direction edge having the highest concentration of stress when the tire is rotating.

Also, according to the first to third modes of embodiment, it is possible to achieve enhanced tread pattern durability and to suppress the decrease in the performance on ice because the separation ds between the circumferential direction edge and the at least one thin incision, between which is formed at least one series of small holes, is between 8.0 mm and 14.0 mm.

Also, according to the first to third modes of embodiment it is possible to achieve enhanced tread pattern durability and to suppress the decrease in the performance on ice because the diameter dh of the small holes constituting the at least one series of small holes is between 1.0 mm and 3.0 mm.

Also, according to the first to third modes of embodiment it is possible to achieve enhanced tread pattern durability and to suppress the decrease in the performance on ice because the separation db between adjacent small holes constituting the at least one series of small holes is between 3.0 mm and 6.0 mm.

Also, according to the first to third modes of embodiment the widened portion 51, 51a, 51b of the at least one elongated incision 5, 5a, 5b is formed in such a way that it has a circular cross-sectional shape which typically exhibits a good balance of heat dissipation, resulting from an increase in the surface area which is in contact with the air, and stress dispersion (suppression of stress concentration), and therefore tread pattern durability can be enhanced and it is also possible to alleviate processing complications when the thin incision having a widened portion 51, 51a, 51b at its bottom is manufactured.

Also, according to the first to third modes of embodiment it is possible to achieve enhanced tread pattern durability and to suppress the decrease in the performance on ice because the diameter dw of the circular cross section of the widened portion 51, 51a, 51b of the at least one elongated incision 5, 5a, 5b is between 1.0 mm and 3.0 mm.

Also, according to the second and third modes of embodiment the tread pattern durability can be effectively enhanced because the blocks 4 aligned in the circumferential direction and having a series of small holes 6, a thin incision 5, 5a, 5b and a circumferential direction edge 42, as described hereinabove, are formed in the tread shoulder portion which serves a more important function than other regions of the tread 1 when the tire is rolling, and which generates more heat than other portions of the tread.

Also, according to the second and third modes of embodiment a thin incision 5, 5a, 5b, in which a widened portion 51, 51a, 51b is formed, is formed in such a way that it opens in a block wall 43 located on the outside of the tread, and therefore degradation due to heat in the material used for the blocks 4 can be more effectively suppressed, thereby enhancing the tread pattern durability, because heat within the block 4 is dissipated through the open portion which opens in the block wall 43 and a high heat dissipation characteristic can thus be obtained.

### EXPLANATION OF THE REFERENCE NUMBERS

1 Winter-use tire tread
2 Circumferential groove
3 Transverse groove
4 Block
41 Surface on block 4 which comes into contact with the road surface when the tire is rolling
42 Circumferential direction edge
43 Block wall
5, 5a, 5b Thin incision
51, 51a, 51b Widened portion of thin incision
6, 6a, 6b Series of small holes
7, 7a, 7b Small hole

1. A tread for a winter-use pneumatic tire having at least one circumferential groove extending in the circumferential direction of the tire, a plurality of transverse grooves extending in the transverse direction of the tire, and a plurality of blocks demarcated by the circumferential grooves and the transverse grooves, wherein
it has blocks which are aligned in the circumferential direction and in which are formed respectively
circumferential direction edges formed by the abovementioned transverse grooves,
at least one thin incision which extends substantially parallel to the abovementioned circumferential direction edges and has a depth equal to or less than the depth of the abovementioned circumferential groove, and which has a widened portion at its bottom,
and at least one series of small holes comprising at least two small holes which open in a ground contacting surface of the block, extend in the inward radial direction of the tire and have a depth equal to or less than the depth of the abovementioned circumferential groove,
and in that the abovementioned at least one series of small holes is formed in a prescribed neighboring region of the abovementioned circumferential direction edge, and is formed in an intermediate portion between the abovementioned circumferential direction edge and the abovementioned at least one thin incision.

2. The tread for a winter-use pneumatic tire according to claim 1, wherein the abovementioned tread for a winter-use pneumatic tire has a prescribed direction of rotation and in that the specific neighboring region of the abovementioned circumferential direction edge is a region neighboring the trailing side circumferential direction edge.

3. The tread for a winter-use pneumatic tire according to claim 2, wherein the separation between the abovementioned circumferential direction edge and the abovementioned at least one thin incision, between which at least one series of small holes is formed, is between 8.0 mm and 14.0 mm.

4. The tread for a winter-use pneumatic tire according to claim 3, wherein the diameter of the small holes constituting the abovementioned at least one series of small holes is between 1.0 and 3.0 mm.

5. The tread for a winter-use pneumatic tire according to claim 4, wherein the separation between adjacent small holes constituting the abovementioned at least one series of small holes is between 3.0 and 6.0 mm.

6. The tread for a winter-use pneumatic tire according to claim 5, wherein the widened portion of the abovementioned at least one elongated incision has a circular cross-sectional shape.

7. The tread for a winter-use pneumatic tire according to claim 6, wherein the diameter of the circular cross section of the abovementioned widened portion is between 1.0 and 3.0 mm.

8. The tread for a pneumatic tire according to claim 7, wherein the abovementioned blocks aligned in the circumferential direction are formed in a tread shoulder portion.

9. The tread for a winter-use pneumatic tire according to claim 8, wherein the abovementioned at least one thin incision is formed in such a way that it opens in a block wall located on the outside of the tread.
